(19) United States
(12) Patent Application Publication
(10) Pub. No.: US 2015/0153182 A1
(43) Pub. Date: Jun. 4, 2015

(54) SYSTEM AND METHOD FOR CALIBRATING A NAVIGATION HEADING

(71) Applicant: Google Inc., (US)

(72) Inventors: Laurent Tu, San Francisco, CA (US); Brian Patrick Williams, Mountain View, CA (US)

(73) Assignee: Google Inc., Mountain View, CA (US)

(21) Appl. No.: 13/761,754

(22) Filed: Feb. 7, 2013

(51) Int. Cl. G01C 21/20; G06F 3/0484

(52) U.S. Cl. CPC G01C 21/206; G06F 3/0484

(57) ABSTRACT

Systems and methods for calibrating a navigation heading are provided. A client device may display navigation information to a user. The client device may display a floor plan of a building with a navigation route superimposed on the floor plan. The client device may also display a video as received from a camera with the navigation route superimposed on the video. By displaying the route on the captured imagery, the client device may direct the user along the route without the user having knowledge of the direction in which they are facing when beginning the route. As the user travels along the route, the heading by which the client device directs the user may grow increasingly inaccurate. Therefore, the client device may include an interface to allow the user to recalibrate the heading (e.g., by straightening a displayed path) to ensure that an accurate navigation path is displayed.

### BACKGROUND

Portable electronic devices, such as smartphones, personal digital assistants (PDAs) and handheld location services devices are capable of performing a variety of functions, including location reporting, mapping, and route-finding operations. These portable electronic devices often include an interface for receiving location information and providing navigation instructions to users. Although most navigation systems rely on navigation satellites to determine location information, these satellite systems are not always available. For example, satellite systems that rely on line-of-sight with the client device typically do not function properly in indoor environments.

One way for providing navigation services in an indoor environment utilizes an internal compass in conjunction with accelerometers and/or gyroscopes to identify the direction in which a device is facing. However, it may be difficult to obtain an accurate compass reading indoors, and each reading of the accelerometer or gyroscope may introduce additional errors into a device heading. As time increases from the original compass reading, this heading may grow increasingly inaccurate.

### BRIEF SUMMARY

A system and method for manually calibrating a navigation heading is provided. A client device may receive heading information, such as from a compass. This heading may be used to provide navigation services. Accelerometers and/or gyroscopes may update the heading received from the compass as the user moves the client device. The user may periodically perform a manual heading update, such as by manipulating an interface control, to update the heading so the client device may continue to provide accurate navigation information.

According to one aspect of the disclosure, a computer-implemented method for calibrating a navigation heading is provided. The method comprises obtaining a heading reading corresponding to an actual heading of a client device; presenting navigation information to a user of the client device using the heading reading, the navigation information indicating a particular direction relative to the heading reading; receiving user input to update the heading reading via at least one human interface device coupled to the client device; and updating, using a processor, the heading reading according to the received user input by altering the heading reading with the received user input without altering the actual heading of the client device.

In one example, the method further comprises presenting a temporary set of navigation information corresponding to a temporary heading while the user input is received, the temporary set of navigation information identifying how the navigation information will be altered when the heading reading is updated. In this case, presenting the temporary set of navigation information may be done by displaying the temporary set of navigation information as a dotted line on a display of the client device.

In another example, the method further comprises receiving a confirmation input from the user after receiving user input indicating the updated heading reading but before updating the heading reading. In a further example, the user input is provided by positioning a cursor along a slider bar of a displayed graphical user interface. In this case, the slider bar may be laterally adjustable to correct for a drift in the heading reading from the actual heading.

According to another example, the method further comprises presenting a confirmation dialogue in response to an attempt by the user to update the heading reading by greater than a threshold value. Here, the threshold value may be determined based on a type of sensor used to provide the heading reading.

In yet another example, the navigation information is presented on a display of the client device as a line superimposed on a video received from a camera coupled to the client device. In another example, the method further comprises updating the navigation information to be presented in the particular direction relative to the updated heading reading. In another example, obtaining the heading reading comprises receiving the heading reading from at least one sensor coupled to the client device. In this case, the at least one sensor may include a compass, a gyroscope, or an accelerometer.

According to another aspect of the disclosure, a non-transitory computer-readable storage medium comprises instructions that, when executed by a processor, cause the processor to perform a method for calibrating a navigation heading. The method comprises obtaining a heading reading corresponding to an actual heading of a client device; presenting navigation information to a user of the client device using the heading reading, the navigation information indicating a particular direction relative to the heading reading; receiving user input to update the heading reading via at least one human interface device coupled to the client device; and updating the heading reading according to the received user input by altering the heading reading with the received user input without altering the actual heading of the client device.

In one example, method further comprises presenting a temporary set of navigation information corresponding to a temporary heading while the user input is received, the temporary set of navigation information identifying how the navigation information will be altered when the heading reading is updated. Here, presenting the temporary set of navigation information may be done by displaying the temporary set of navigation information as a dotted line on a display of the client device. And in another example, obtaining the heading reading comprises receiving the heading reading from at least one sensor coupled to a client device.

According to another aspect, a processing system for calibrating a navigation heading is provided. The processing system comprises at least one sensor for determining a navigation heading, at least one display, at least one human interface device, and at least one processor. The processor is configured to: receive an initial heading reading from the at least one sensor; display navigation information on the at least one display, the navigation information displayed in a particular direction relative to the initial heading reading; receive user input via the human interface device to update the initial heading reading by specifying a calibrated heading, the user input specifying the calibrated heading reading without altering an actual heading of the processing system; and update the initial heading reading to the calibrated heading reading.

In one example, the initial heading reading is updated to the calibrated heading reading in response to selection of a confirmation interface element. In another example, the at least one processor is further configured to update the navigation information to be displayed in the particular direction relative to the calibrated heading reading. In a further example, the at least one processor is also configured to display a confirmation dialogue in response to an attempt by the user to update the heading reading by greater than a threshold value. In this case, the threshold value is determined based on a type of sensor used to provide the heading reading. And in another alternative, the processing system further comprises a camera. Here, the navigation information is displayed on the display as a line superimposed on a video received from the camera.

### BRIEF DESCRIPTION OF THE DRAWINGS

FIG. 1 is a block diagram depicting an example of a client device for performing a manual navigation heading update in accordance with aspects of the disclosure.

FIG. 2 is an illustration of an example of an interface for manually updating a navigation heading in accordance with aspects of the disclosure.

FIG. 3 is an illustration of another example of an interface for performing a manual navigation heading update in accordance with aspects of the disclosure.

FIG. 4 is a flow diagram depicting an example of a method for providing navigation services using manual heading updates in accordance with aspects of the disclosure.

FIG. 5 is a flow diagram depicting an example of a method for manually updating a navigation heading in accordance with aspects of the disclosure.

FIGS. 6A-B illustrates an example of heading correction according to aspects of the disclosure.

### DETAILED DESCRIPTION

The aspects, features and advantages of the present disclosure will be appreciated when considered with reference to the following description of preferred embodiments and accompanying figures. The following description does not limit the disclosure; rather, the scope is defined by the appended claims and equivalents. While certain processes in accordance with example embodiments are shown in the figures as occurring in a linear fashion, this is not a requirement unless expressly stated herein. Different processes may be performed in a different order or concurrently.

The disclosure describes systems and methods for mapping indoor and other environments. Aspects of the disclosure provide a flexible, portable, user-friendly system for manually updating a navigation heading during a navigation operation such as, for example, during an indoor navigation operation. Elements of the system relate to displaying a navigation route to a user, and allowing the user to manually calibrate the heading of the client device to ensure accuracy of the navigation route. While examples herein may be directed to indoor environments, the aspects of the disclosure are also applicable to outdoor environments.

A client device may display navigation information to a user. For example, the client device may display a floor plan of a building with a navigation route superimposed on the floor plan. The client device may also display a video as received from a forward facing camera, with the navigation route superimposed on the video. By displaying the route on a video captured by a device camera, the client device may direct the user along the route without the user having knowledge of the direction in which they are facing when beginning the route. As the user travels along the route, the heading (current direction of movement) by which the client device directs the user may grow increasingly inaccurate. As such, the client device may include an interface to allow the user to recalibrate the heading (e.g., by straightening a displayed path down a hallway) to ensure that an accurate navigation path is displayed.

For situations in which the systems and methods described herein collect information about users, the users may be provided with an opportunity to opt in/out of programs or features that may collect personal information (e.g., information about a user's location, a user's preferences, or a user's location history). In addition, certain data may be anonymized and/or encrypted in one or more ways before it is stored or used, so that personally identifiable information is removed. For example, a user's identity and location may be anonymized and encrypted so that the personally identifiable information cannot be determined or associated for the user and so that identified user preferences or user interactions are generalized (for example, generalized based on user demographics) rather than associated with a particular user.

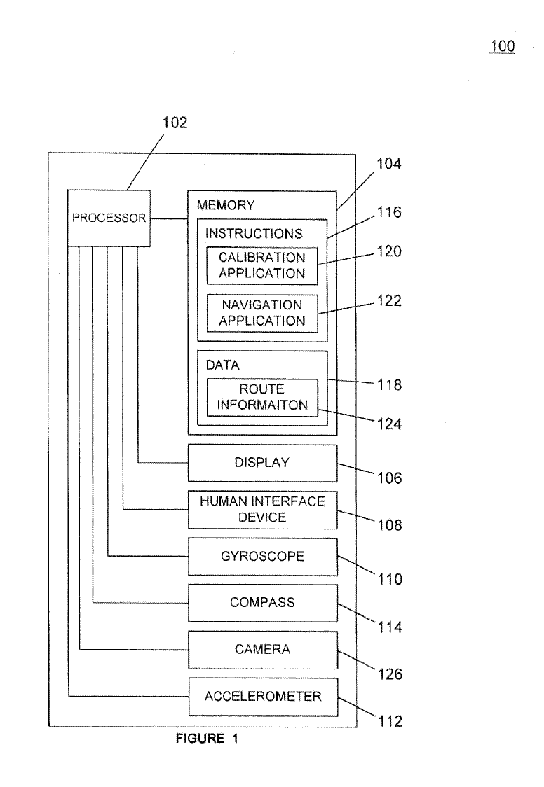

FIG. 1 is a block diagram depicting an example of a client device 100 for providing navigation services and performing a manual update to a navigation heading in accordance with aspects of the disclosure. The client device 100 may be computing device as known in the art. For example, the client device 100 may be laptop computer, a desktop computer, a netbook, a rack-mounted server, a smartphone, a cellular phone, a tablet computer, or any other device containing programmable hardware or software for executing instructions. Although aspects of the disclosure generally relate to a portable device, the client device 100 may be implemented as multiple devices with both portable and non-portable components (e.g., software executing on a rack-mounted server with a mobile interface for gathering location information). As shown in FIG. 1, an example of the client device 100 may include a processor 102 coupled to a memory 104 and other components typically present in general purpose computers. The processor 102 may be any processor capable of execution of computer code, such as a central processing unit (CPU). Alternatively, the processor 102 may be a dedicated controller such as an application-specific integrated circuit (“ASIC”) or other processing device.

The client device 100 may have all of the components normally used in connection with a wireless mobile device such as CPU 102, memory 104 (e.g., RAM and ROM) storing data 118 and instructions 116, an electronic display 106 (e.g., a liquid crystal display (“LCD”) screen or touch-screen), a human interface device 108 (e.g., a keyboard, touch-screen or microphone), a camera 116, a speaker (not shown), a network interface component (not shown), and all of the components used for connecting these elements to one another. Some or all of these components may all be internally stored within the same housing, e.g. a housing defined by a plastic shell and LCD screen.

The memory 104 may store information that is accessible by the processor 102, including instructions 116 that may be executed by the processor 102, and data 118. The memory 104 may be of any type of memory operative to store information accessible by the processor 102, including a computer-readable medium, or other medium that stores data that may be read with the aid of an electronic device, such as a hard-drive, memory card, read-only memory (“ROM”), random access memory (“RAM”), digital versatile disc (“DVD”) or other optical disks, as well as other write-capable and read-only memories. The system and method may include different combinations of the foregoing, whereby different portions of the instructions and data are stored on different types of media.

The instructions 116 may be any set of instructions to be executed directly (such as machine code) or indirectly (such as scripts) by the processor 102. For example, the instructions 116 may be stored as computer code on the computer-readable medium. In that regard, the terms “instructions” and “programs” may be used interchangeably herein. The instructions 116 may be stored in object code format for direct processing by the processor 102, or in any other computer language including scripts or collections of independent source code modules that are interpreted on demand or compiled in advance.

The instructions 116 may comprise a calibration application 120 for specifying a navigation heading and a navigation application 122 for providing navigation services, such as route-finding and indoor navigation. The calibration application 120 may receive compute heading information based on data received from a compass 114, a gyroscope 110, and/or an accelerometer 122, and interface with the navigation application 122 to provide the heading to direct the user along a particular path. The calibration application 120 may receive input from a user to calibrate a heading for the client device 100, such as in a case where the heading information has become inaccurate.

The calibration application 120 and the navigation application 122 may be an “app” executing on a mobile device, such as a smart phone. For example, a user may download the calibration application 120 and/or the navigation application 122 from an application marketplace such as the ANDROID MARKETPLACE.

While the calibration application 120 and the navigation application 122 may be implemented as distinct applications, they may also be integrated with other programs or elements of the client device 100 to provide similar functionality and other functionalities. The instructions 116 may be implemented as software executed on the processor 102 or by other processing devices, such as ASICs or field-programmable gate arrays (“FPGAs”).

The data 118 may be retrieved, stored or modified by the processor 102 in accordance with the instructions 116. For instance, although the architecture is not limited by any particular data structure, the data may be stored in computer registers, in a relational database as a table having a plurality of different fields and records, Extensible Markup Language (“XML”) documents or flat files. The data may also be formatted in any computer readable format such as, but not limited to, binary values or Unicode. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

Portions of the data 118 may comprise route information 124. The route information 124 may be determined by the navigation application 122, or received from a remote server (not shown) in response to a navigation query issued by the navigation application. The route information 124 may define a path by which the user may travel to reach an intended destination. The route information 124 may be displayed on a display 106 as a superimposed line on a video captured using the camera 116. Heading information from the calibration application 120 may be used to determine the facing of the client device to ensure that the superimposed route is accurately displayed on the display 106.

The client device 100 may further comprise a display 106. The display 106 may function to provide an interface for the user. The display 106 may be implemented as any display device, such as a liquid crystal display (“LCD”), cathode-ray tube (“CRT”), or light-emitting diode (“LED”) display device. The display 106 may further allow the user to input data or commands, such as by including touch-screen technology. The display 106 may include a monitor having a screen, a projector, a television, a computer printer or any other device that is operable to display information. The client device 100 may accept user input via other components such as a mouse (not pictured). Indeed, devices in accordance with the systems and methods described herein may comprise any device operative to process instructions and transmit data to and from humans and other computers including general purpose computers, network computers lacking local storage capability, etc.

The client device 100 may further include one or more human interface devices 108. These human interface devices 108 provide a way for the user to provide commands and direction to the client device 100 and software executing thereon, such as the calibration application 120 or the navigation application 122. The human interface device 108 may include any device that allows for such input. For example, the human interface device 108 may include a keyboard, a trackball, a mouse, or a touch-screen. The human interface device 108 may also be integrated with the display 106 (e.g., as part of a touch-screen), or other elements of the client device 100, such as by interacting with the client device 100 by gestures or shaking using an accelerometer 112 or gyroscope 110.

The client device 100 may also include one or more gyroscopes 110 and/or accelerometers 112. The gyroscope 110 and/or accelerometer 112 may function to track movement of the client device 100, such as by determining a direction of acceleration or measuring force acting on the client device 100. For example, the gyroscope 110 and/or accelerometer 112 may identify when the user takes a step by measuring the impact of the user's footfall on the client device 100. The client device 100 may include multiple gyroscopes 110 and/or accelerometers 112 for measuring acceleration along different axes.

The client device 100 may further comprise a compass 114. The compass 114 may provide a heading for the client device 100 by employing one or more sensors to measure a magnetic field. For example, the compass 114 may output either a digital or analog signal proportional to its orientation. The signal may be read by a controller or microprocessor to interpret the heading of the client device 100. In some aspects, the compass 114 may be a gyroscopic compass, or a traditional “needle” compass. Any compass capable of providing bearing information would be suitable for aspects of the disclosure.

The client device 100 may also include a camera 116. The camera 116 may function to capture image data according to the facing of the client device 100. For example, the camera 116 may capture image data in front of the client device 100 such that the area in front of the client device 100 is displayed on the display 106, with a navigation route superimposed on the area in front of the client device 100 as displayed on the display 106, in order to guide the user along the route.

Although FIG. 1 functionally illustrates the processor 102 and memory 104 as being within the same block, the processor 102 and memory 104 may actually comprise multiple processors and memories that may or may not be stored within the same physical housing. Accordingly, references to a processor, computer or memory will be understood to include references to a collection of processors, computers or memories that may or may not operate in parallel.

The client device 100 may be at a first node of a network (not shown). The client device 100 may be operative to directly and indirectly communicate with other nodes of the network. For example, the client device 100 may comprise a mobile device that is operative to communicate across the network such that the client device 100 uses the network 142 to transmit and display information from a remote device to a user of the client device 100. The client device 100 may also comprise a plurality of computers that exchange information with different nodes of a network for the purpose of receiving, processing and transmitting data to the client devices.

The client device 100 may communicate with the network using various configurations and various protocols including the Internet, World Wide Web, intranets, virtual private networks, local Ethernet networks, private networks using communication protocols proprietary to one or more companies, cellular and wireless networks (e.g., Wi-Fi), instant messaging, hypertext transfer protocol (“HTTP”) and simple mail transfer protocol (“SMTP”), and various combinations of the foregoing. Although only a single client device is depicted in FIG. 1, it should be appreciated that a typical system may include a large number of connected computers.

Although some functions are indicated as taking place on the client device 100 and other functions are indicated as taking place on the server 104, various aspects may be implemented by a single computer having a single processor. Although certain advantages are obtained when information is transmitted or received as noted above, other aspects of the system and method are not limited to any particular manner of transmission of information. For example, in some aspects, information may be sent via a medium such as an optical disk or portable drive. In other aspects, the information may be transmitted in a non-electronic format and manually entered into the system.

The system and method may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is operative to identify a geographic locations (e.g., lot and block numbers on survey maps). Moreover, a location may define a range of the foregoing.

The system and method may further translate locations from one reference system to another. For example, the client device 100 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other references systems as well.

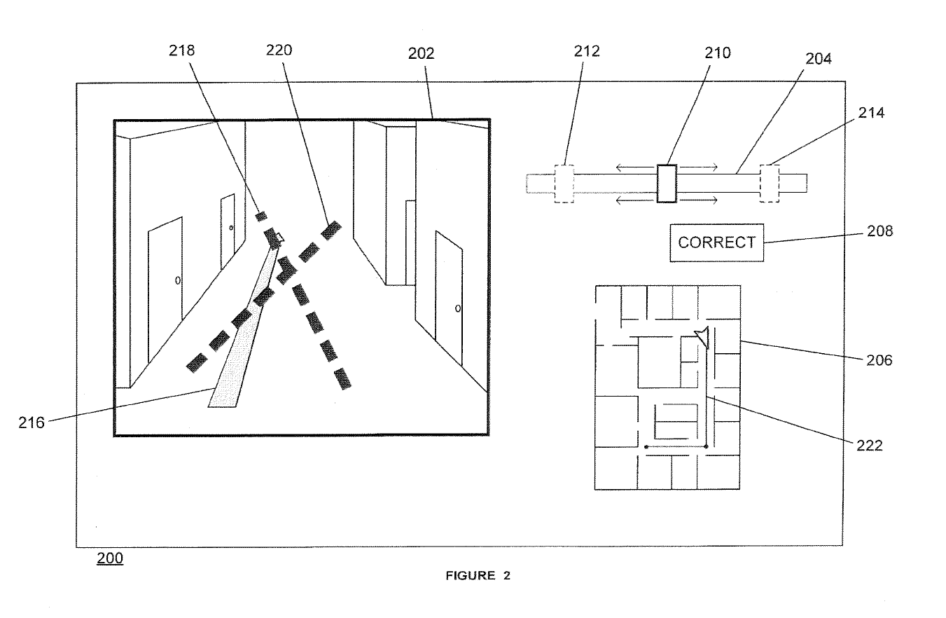

FIG. 2 is an illustration of an example of an interface 200 for manually updating a navigation heading in accordance with aspects of the disclosure. The interface 200 depicts a video image 202, a calibration input 204 shown as a slider, a confirmation button 208 for updating the heading, and a location map 206.

The video image 202 may depict the local area in front of or around the client device 100. For example, the video image 202 may include an image received from a camera 116 on the front of the client device 100. As the client device 100 moves around, the video image 202 may update to reflect the new environment around the client device 100. The video image 202 may further have one or more routes superimposed on the environmental image. In the present example, three alternative routes are displayed. The first route 216 is a path traveling straight down a hallway depicted in the video image. This route corresponds to the path along which the user is being directed to their destination, as shown in the location map 206. The second path 218 and the third path 220 as represented by the dotted lines, represent calibrated versions of the first path 216, as modified using the calibration slider 204. In the example depicted in the video image 202, there is no need to calibrate the heading, as the path corresponding to the path in the location map 206 is already straight down the hallway.

The calibration slider 204 allows for adjustment of the path displayed in the video image 202. In indoor locations where location satellites do not have line of sight and where compass readings may be inaccurate, headings are often determined by using a last known accurate reading (e.g., an outdoor compass reading), and applying updates from accelerometers and/or gyroscopes to determine movement of the client device 100 relative to the last known accurate reading. Over time, small errors in these readings may accumulate, leading to inaccurate heading data being used in route finding operations. This heading data may be used in systems, such as the video image 202, which show the user a proper path in their environment. As the error accumulates, a displayed path may become increasingly inaccurate, to the point where the path may appear to travel through walls or otherwise inaccessible areas. The calibration slider 204 allows for the user to manually adjust the heading used by the client device 100 to display the path, ensuring that accurate heading data is used when displaying the path to the user.

The calibration slider 204 may include a slider control 210. In the default state, the slider control 210 may be in the center of the calibration slider 204. As the slider control 210 is moved along the calibration slider 204, the path displayed in the video image 202 changes. For example, when the slider control 210 is moved to a first position 212, the first path 216 may rotate to display the second path 218 in the video image 202, due to modification of the perceived heading of the client device 100. In other words, the calibration operation may calibrate the client device 100 to the right of its actual heading. When moving the slider control 210 in the opposite direction, the heading may be adjusted in the opposite direction, such that moving the slider control 210 to the second position 214 may result in the third path 220, where the client device 100 is calibrated to the left of its actual heading. As the heading of the device is calibrated, a temporary path may be displayed in the video window to indicate the direction of the new path after the calibration is complete. The user may indicate that the calibration operation is complete by pressing the confirmation button 208 (labeled as “correct”). Upon adjusting the path, the user may select the confirmation button 208 to confirm the newly calibrated heading.

The location map 206 depicts the path 222 of the client device 100 to its destination within the building. A user may reference this location map 206 to ensure that the path is properly pointing down the correct hallway, and that the displayed path 216 matches the path 222 in the location map 206.

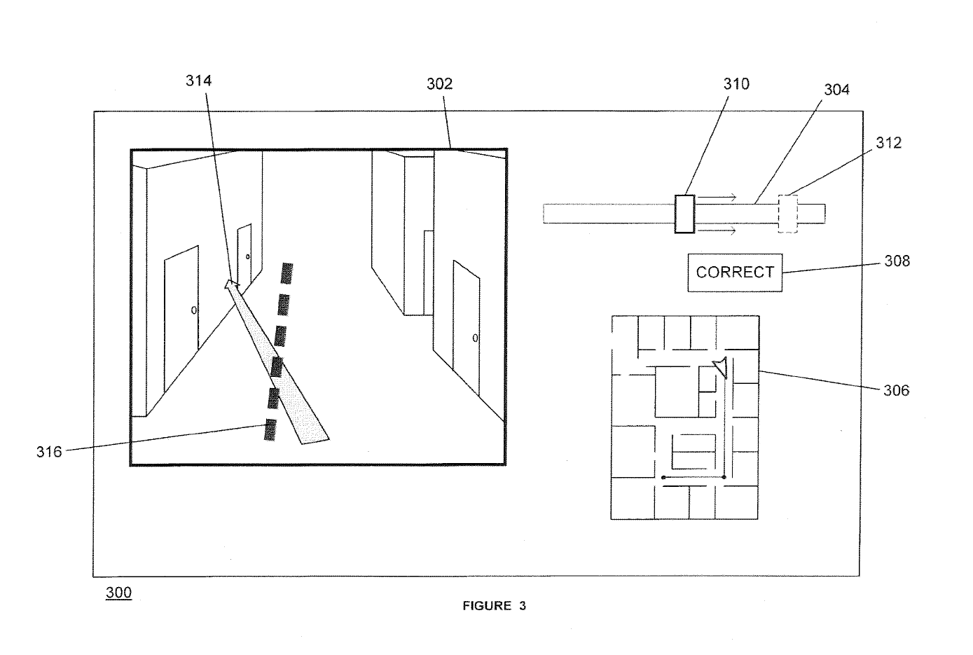

FIG. 3 is an illustration of another example of an interface 300 for performing a manual navigation heading update in accordance with aspects of the disclosure. As with the interface 200, the interface 300 includes a video image 302, a calibration slider 304, and a location map 306.

The video image 302 depicts a scenario where the location path 314 is incorrectly displayed as traveling through a wall, where the proper path 316, shown in broken lines, would be straight down the hallway. Such a circumstance is typical where the heading of the device has grown inaccurate due to error introduced by accelerometer and/or gyroscope readings over time. As such, in order to display accurate path data in the video image 302, it is necessary to calibrate the path to properly indicate the location along which the user should travel. The user may perform this calibration using the calibration slider 304.

The default position of the slider control 310 may result in the path 314 passing through the wall in the video image 302. As the slider control 310 is moved to a first position 312, the path may be reconfigured to the second path 316. When the calibration operation is ongoing, the path 316 may be depicted as a dotted line. When the user accepts the calibration by pressing the confirmation button 308 (labeled as “correct”), the path may change from a dotted line to a solid line.

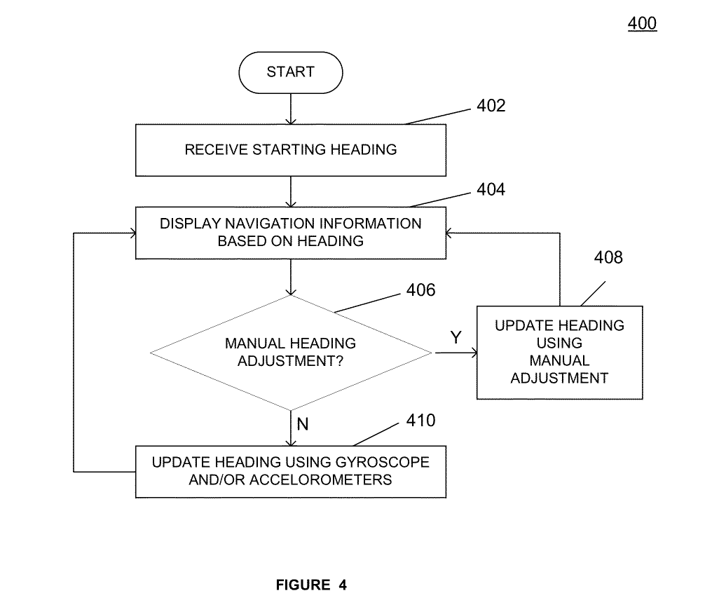

FIG. 4 is a flow diagram depicting an example of a method 400 for providing navigation services using manual heading updates in accordance with aspects of the disclosure. The method 400 provides the user with navigation services, such as displaying a path of travel on a video display, as described above (see FIGS. 2 and 3). During the navigation process, compass, accelerometer, and gyroscope readings may be used to display an accurate path on the video display. However, as time progresses, the path may drift due to aggregate error received from accelerometer and gyroscope readings and the inability to receive an accurate compass heading in an indoor environment. The method 400 provides the user with the capability to manually calibrate this display to ensure that the displayed path remains accurate.

At action 402, a starting heading is received. For example, a client device 100 may request a heading from a compass coupled to the client device. Alternately, the heading may be received by methods other than using a compass. For example, the client device 100 may estimate a heading using data received from navigation satellites, via location estimation using cell phone tower triangulation, or by any other means of determining a direction of the client device 100. The received heading is used as a starting or initial heading, from which future headings may be calculated.

At action 404, navigation information is displayed in accordance with the received heading. For example, where the client device 100 displays a navigation path on a video display (see, e.g., FIGS. 2 and 3), the heading may be used to determine which direction a path should be superimposed on the video display to indicate the direction in which the user should travel to reach a desired destination.

At action 406, a user may enter a manual heading adjustment to calibrate the display of the navigation information on the display. For example, the user may use a slider bar to align a path down a hallway, as described with respect to FIGS. 2 and 3. The video display may show the path to the user as the heading is updated, allowing the user to align the path with their direction of travel. During the alignment process, the user may reference a map of the local area (e.g., a floor plan) to point the path in the proper direction. For example, a hallway may extend in two directions, and the user may identify the proper direction in which to align the superimposed path by determining which direction the map indicates the user should travel.

The user may also choose the direction by known landmarks, or the client device 100 may alert the user if the calibrated path deviates too far from the expected path. For example, if the user attempts to calibrate the facing of the client device 100 in a due south direction, but the previously expected facing of the client device 100 is due north, the client device 100 may prompt the user to ask if they are sure about the calibration. Such a prompt may be displayed where the calibration adjustment exceeds a particular threshold value, such as where the threshold is 15 degrees, 30 degrees, or 90 degrees. The threshold may be dynamically determined based on the method previously used to identify the device heading. For example, a heading determined by a confident compass reading (namely, a reading that is likely correct or very close to correct) may have a lower calibration threshold than a heading determined using the accumulation of orientation updates from the accelerometer and gyroscope readings (a reading that is likely to be less accurate).

At action 408, the heading may be updated to the newly calibrated heading if the user has performed a manual adjustment. The method then returns to action 404 where navigation information is displayed based on the newly calibrated heading.

At action 410, the heading may be updated using alternative measures, such as by using an accelerometer or gyroscope attached to the client device 100 to attempt to determine a heading for the client device. The method 400 may continue to allow for determination of headings in this manner as long as the user uses the client device 100 for providing navigation services.

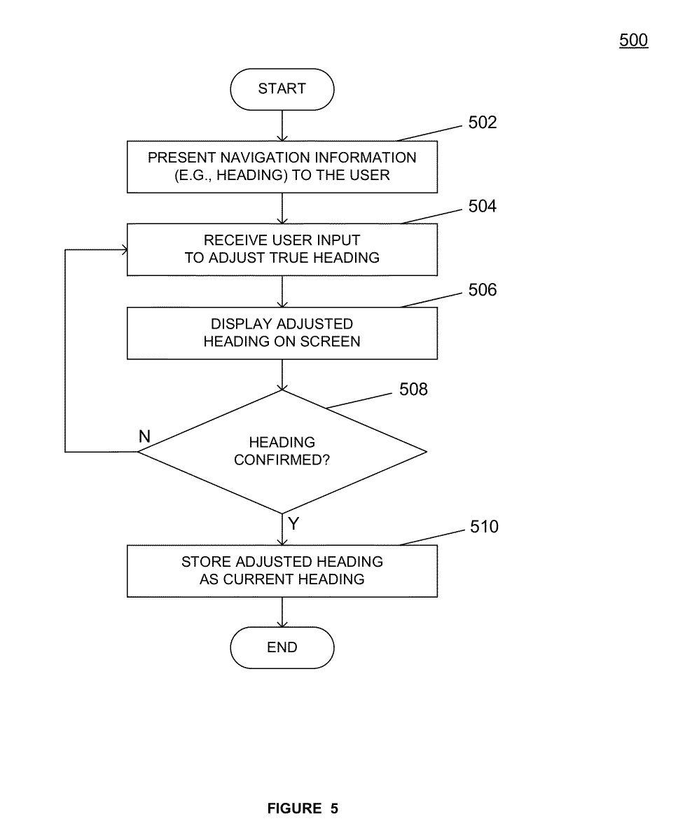

FIG. 5 is a flow diagram depicting an example of a method 500 for manually updating a navigation heading in accordance with aspects of the disclosure. The method 500 allows for the user to manually update the heading of the client device 100 when the heading begins to drift. The user may initiate a heading update at any time, and the client device 100 may allow the user to perform the method 500 to determine the initial heading. As the user travels, if the client device 100 cannot obtain a new heading from a compass, the heading may begin to drift. The method 500 allows the user to use an interface control of the client device 100 to specify a new heading. During the heading update process, the client device 100 may display the effects of the newly calibrated heading to assist the user in the calibration process.

At action 502, navigation information is displayed on the screen, or otherwise presented to the user. This navigation information may be displayed in accordance with a current heading of the client device 100. Navigation information may be displayed as a path superimposed on a display screen, where the direction of the path is determined by the current heading of the device and the intended destination. For example, if the destination is down a hallway to the south, and the client device 100 is facing east, then the navigation information may display a path leading to the right of the video display. As the heading of the client device 100 changes, the navigation information may update. Over time, the heading may become inaccurate if the client device 100 is unable to accurately determine the facing of the client device 100, such as where the client device 100 relies on the accumulation of orientation updates from accelerometers and/or gyroscopes to estimate the heading. As the heading becomes inaccurate, the navigation information may also become inaccurate, such that the superimposed path may travel in the wrong direction, through a wall, or be otherwise inaccurate.

At action 504, the user may perform an input operation to adjust the true heading (see e.g., FIGS. 2 and 3), which is received by the client device 100. As the user manipulates an interface element (e.g., a slider bar, a mouse cursor, or a keyboard), the true heading may be altered. As the true heading is altered, the client device 100 may display the effects of the altered heading on the display at action 506. For example, as the user manipulates the interface control to modify the true heading, the path that indicates the direction of travel may move on the screen in accordance with the new heading.

At action 508, the user may confirm the heading that was specified using the interface control. If the user does not confirm the heading, the user may continue to manipulate the heading using the interface control at action 504. If the user confirms the new heading, then the new heading is used to calibrate the heading of the client device 100, and stored as the current heading of the client device 100 for navigation purposes as shown at action 510.

The actions of the illustrated methods described above are not intended to be limiting. The functionality of the methods may exist in a fewer or greater number of actions than what is shown and, even with the depicted methods, the particular order of events may be different from what is shown in the figures and include additional stages or omit stages as shown.

The systems and methods described above advantageously provide a flexible, user-friendly method and system for calibrating a device heading. Such a system is capable of being utilized by users with a variety of consumer electronics, such as smartphones and PDAs, to map their indoor environments for use in navigation operations. As such, users may take advantage of navigation services in circumstances where it may not be otherwise possible to obtain accurate heading information. This allows for accurate navigation information to be displayed in real-time via a video display, whereas previously users might only be able to rely on a static map that does not indicate a direction facing. The system may also provide error checking to ensure that calibrated headings are likely to be accurate, which may dynamically adjust depending upon the method by which the headings are obtained.

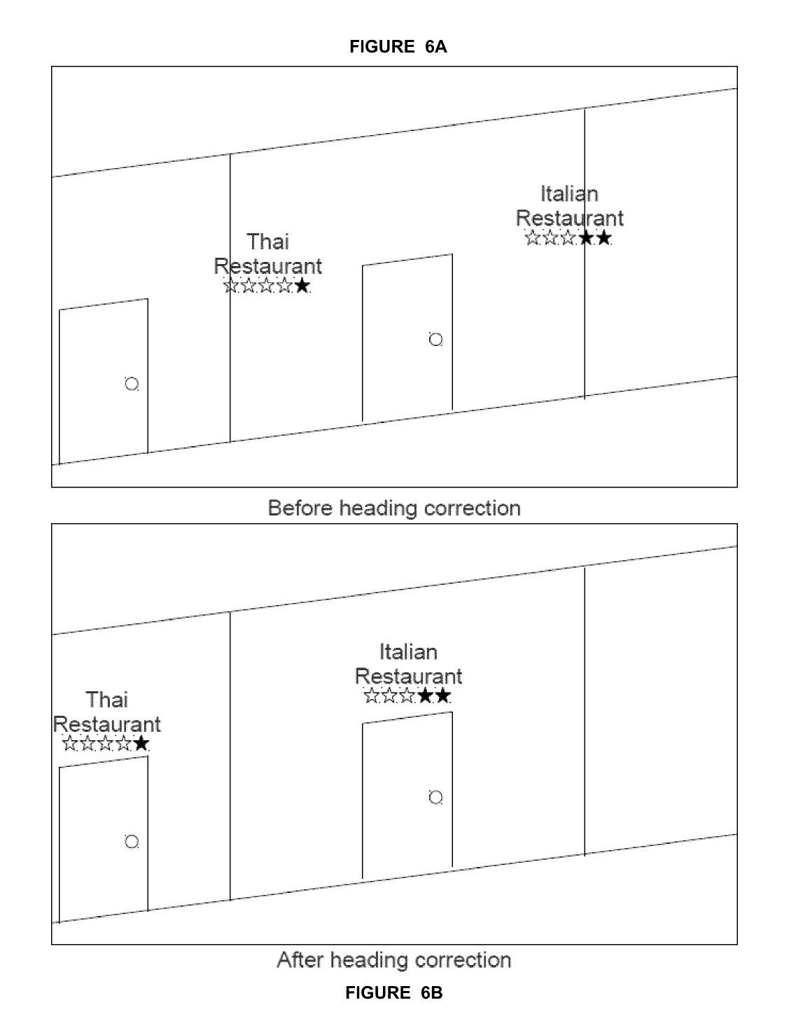

Furthermore, the technology described herein may be employed for more than correcting the heading used for navigation purposes. For instance, an application could display other useful information relating to the world on a video image. Thus, as shown in FIGS. 6A-B, star ratings for restaurants in a mall are misaligned (FIG. 6A) on the display until the heading is corrected (FIG. 6B) using the techniques discussed above.

As these and other variations and combinations of the features discussed above can be utilized without departing from the disclosure as defined by the claims, the foregoing description of the embodiments should be taken by way of illustration rather than by way of limitation of the disclosure as defined by the claims. It will also be understood that the provision of examples of the disclosure (as well as clauses phrased as “such as,” “e.g.”, “including” and the like) should not be interpreted as limiting the disclosure to the specific examples; rather, the examples are intended to illustrate only some of many possible embodiments.

1. A computer-implemented method for calibrating a navigation heading, the method comprising:
obtaining, by one or more processors, a heading reading corresponding to an actual heading of a client device;
presenting, by the one or more processors using a display of the client device, navigation information to a user of the client device using the heading reading, the navigation information indicating a path along a particular direction relative to the heading reading;
receiving, by the one or more processors user input to update the heading reading via at least one human interface device coupled to the client device; and
updating, using the one or more processors, the heading reading according to the received user input by altering the heading reading with the received user input without altering the actual heading of the client device.

2. The method of claim 1, further comprising presenting a temporary set of navigation information corresponding to a temporary heading while the user input is received, the temporary set of navigation information identifying how the navigation information will be altered when the heading reading is updated.

3. The method of claim 2, wherein presenting the temporary set of navigation information is done by displaying the temporary set of navigation information as a dotted line on a display of the client device.

4. The method of claim 1, further comprising receiving a confirmation input from the user after receiving user input indicating the updated heading reading but before updating the heading reading.

5. The method of claim 1, wherein the user input is provided by positioning a cursor along a slider bar of a displayed graphical user interface.

6. The method of claim 5, wherein the slider bar is laterally adjustable to correct for a drift in the heading reading from the actual heading.

7. The method of claim 1, further comprising presenting a confirmation dialogue in response to an attempt by the user to update the heading reading by greater than a threshold value.

8. The method of claim 7, wherein the threshold value is determined based on a type of sensor used to provide the heading reading.

9. The method of claim 1, wherein the navigation information is presented as a line superimposed on a video received from a camera coupled to the client device.

10. The method of claim 1, further comprising updating the navigation information to be presented in the particular direction relative to the updated heading reading.

11. The method of claim 1, wherein obtaining the heading reading comprises receiving the heading reading from at least one sensor coupled to the client device.

12. A non-transitory computer-readable storage medium comprising instructions that, when executed by a processor, cause the processor to perform a method for calibrating a navigation heading, the method comprising:
obtaining a heading reading corresponding to an actual heading of a client device;
presenting, on a display of the client device, navigation information to a user of the client device using the heading reading, the navigation information indicating a path along a particular direction relative to the heading reading;
receiving user input to update the heading reading via at least one human interface device coupled to the client device; and
updating the heading reading according to the received user input by altering the heading reading with the received user input without altering the actual heading of the client device.

13. The non-transitory computer-readable storage medium of claim 12, wherein the method further comprises presenting a temporary set of navigation information corresponding to a temporary heading while the user input is received, the temporary set of navigation information identifying how the navigation information will be altered when the heading reading is updated.

14. The non-transitory computer-readable storage medium of claim 12, wherein obtaining the heading reading comprises receiving the heading reading from at least one sensor coupled to a client device.

15. A processing system for calibrating a navigation heading, the processing system comprising:
at least one sensor for determining a navigation heading;
at least one display;
at least one human interface device; and
at least one processor configured to:
receive an initial heading reading from the at least one sensor;
display navigation information on the at least one display, the navigation information indicating a path along a particular direction relative to the initial heading reading;
receive user input via the human interface device to update the initial heading reading by specifying a calibrated heading, the user input specifying the calibrated heading reading without altering an actual heading of the processing system; and
update the initial heading reading to the calibrated heading reading.

16. The processing system of claim 15, wherein the initial heading reading is updated to the calibrated heading reading in response to selection of a confirmation interface element.

17. The processing system of claim 15, wherein the at least one processor is further configured to update the navigation information to be displayed in the particular direction relative to the calibrated heading reading.

18. The processing system of claim 15, wherein the at least one processor is further configured to display a confirmation dialogue in response to an attempt by the user to update the heading reading by greater than a threshold value.

19. The processing system of claim 18, wherein the threshold value is determined based on a type of sensor used to provide the heading reading.

20. The processing system of claim 15, wherein:
the processing system further comprises a camera; and
the navigation information is displayed as a line superimposed on a video received from the camera.
